(19) United States
(12) Patent Application Publication
(10) Pub. No.: US 2015/0127490 A1
(43) Pub. Date: May 7, 2015

(54) SYSTEM AND A METHOD TO RECOGNIZE A PRODUCT

(71) Applicant: Reve AB, Stockholm (SE)

(72) Inventor: Josep Maria Nolla Puertas, Stockholm (SE)

(21) Appl. No.: 14/139,965

(22) Filed: Dec. 24, 2013

(30) Foreign Application Priority Data
Nov. 1, 2013 (SE) 1300684-6

(51) Int. Cl. G06Q 30/06; H04M 1/725

(52) U.S. Cl. CPC G06Q 30/0625; G06Q 30/0639; H04M 1/72572; H04M 1/72561
USPC 705/26.62

(57) ABSTRACT

A system, and a method adapted to recognize a physical product at a retailer's physical outlet through a cellular device, having a geographic positioning signaling means, utilized by a user of it. Product price tags are scanned, decoded, and the output data is queried against a product database to search for product matches. If there are multiple matches geographical positioning coordinates from the cellular device GPS, base stations or WI-FI access points are utilized to pick the correct product information in the database, which is then stored in a user database.

### RELATED APPLICATION

This application claims priority of Swedish Patent Application No. 1300684-6, filed Jan. 11, 2013, which is hereby incorporated by reference.

### TECHNICAL FIELD

The present invention pertains to a system and a method adapted to recognize a physical product through a cellular device, having a geographic positioning signaling means, utilized by a user of it.

### BACKGROUND ART

Evolution of commerce is an unending process. With the technological changes taking place, commerce is growing every day. Commerce has been mainly a physical activity (with exceptions like catalogue services) until the last 20 years, in which the irruption of the Internet has created a new commerce channel: the digital or online channel (“e-commerce”). E-commerce's growth has had an impact on markets and retailers, leading to intensified price competition (economies of scale and lower prices), as it has also increased consumers' ability to gather information about products and prices. As a result of this, most merchants have had to adapt their strategies and integrate both offline and online presences (aka “brick and click”).

But retailers are now facing new rising challenges based on the evolution of some trends. The tremendous growth in mobile communications has affected our lives significantly. The mobile phone is now pervasive and used in virtually every sector of human activity—private, business, and government. Its usage is not restricted to making basic phone calls; instead, digital content, products, and services are offered. This is due to a combination of factors such as improved technologies, faster networks, lower prices, better devices, etc.

Smartphones have revolutionized the way we interact with the society. They have become an important tool of our daily lives and people are depending a lot on their smartphones and apps to manage their daily tasks. Currently, the smart phone has introduced its users to numerous application programs (apps) which perform tasks that no one fifteen years ago thought were possible to accomplish with a phone. The phone is utilized in business, for amusement, games/gambling, shopping, tickets, character recognition, payments, and in a lot more of technical fields. But there are still applications for the smart phone not yet invented.

It is an ongoing digital distribution revolution. Different app and software stores have revolutionized the way marketers have been distributing their software and/or mobile content. The current app economies allow any individual to target global consumers in a very cost-effective manner.

Moreover, Object recognition and computer vision are commonly utilized in this technical field. The computer vision field has developed extraordinarily during the last years. One of the typical computer vision tasks is to determine whether or not the image data contains some specific object, feature, or activity, i.e. recognition. There are different varieties of recognition techniques: object recognition, image recognition, content-based image retrieval, optical character encoding (OCR) or 2D code scanning, i.e. barcodes or QR codes. Some of these techniques, such as 2D code scanning, are widely adopted and available to most mobile devices while others like object and image recognition are starting to be tested with mass consumers, i.e. Google Goggles, Google Glass, RedLaser, and others.

Retailers are undergoing a digital transformation. As an example, retail giant Debenhams has launched a new big data initiative to create a more personalized, multi-channeled marketing strategy. The UK-based company—founded in 1778—has approximately 170 stores, and this heritage has seen it build a complex landscape of data. It now plans to use big data to analyze its 40 different databases—which include email lists, mobile users, and customers of its wedding services—in order to understand the individual preferences of its customers and shape its marketing communications accordingly. To provide an outstanding shopping experience while increasing sales and protecting profits is always a balancing act for retailers. Retailers are turning more and more to business analytics with data streams from various areas of the retail operations to help decision makers improve the customer shopping experience.

This article from the New York Times illustrates perfectly the challenges and changes that are occurring in the high street retail landscape: http://www.nytimes.com/2013/07/15/business/attention-shopper-stores-are-tracking-your-cell.html?pagewanted=1&src=me&_r=1&

The combination of these trends converges into a bigger and rapidly evolving tendency, mobile commerce. Customers don't just research information or shop online, they use their phones for price comparisons and even to locate stores. Improved memory, faster processors and bigger screens mean smartphones are easier to use, applications freeze less often and data is current and accessible. Mobile can be seen an opportunity for retailers to leverage the benefits of mobility and multi-channel linking.

However, despite such improvements, many mobile users claim they would use their mobiles more if the purchasing process wasn't so cumbersome, products were easier to find, if the experience between offline and online, and even between web and mobile, was more seamless, and if their devices supported secured transactions.

### SUMMARY OF THE INVENTION

One aim among others of the present invention is to significantly improve the consumers' shopping experience. To do this, a system has been developed, and a method to recognize and interact with commercial products via cellular devices, the “mobile application” or the “app”, which allows its users to have high engagement levels with the products they like in accordance with the present invention. The mobile application brings the digital world benefits to assist the consumers during their physical retail experience.

Hence, the present invention sets forth a system adapted to recognize a product through a cellular device, having a geographic positioning signaling means, utilized by a user of it. The invention thus comprises:
a web scraping means to extract digital signals of product information from retailers' public websites;
a product database, wherein the extracted digital signals of the product information are indexed, categorized and stored in a catalogue file for the retailer, and the retailers' physical outlets geographical positioning coordinate signals are stored in the database;
a user's database, wherein recognized digital signals of the product information are stored in a file created by the user by online signaling of authorization to utilize the file;
at least one digital signaling application program interface (API) adapted for a retailer to connect to the product database catalogue file to update the digital signals of product information;
a digitally stored application program (app) in the cellular device, providing the cellular device user to read a price tag with coded information regarding a product from the product in real time in a retailers' physical outlet;
a location source in proximity to the user of the cellular device utilized to provide geographic positioning coordinate signals (GPS), whose position is accurately pin-pointed through its geographic position, thus geographically locating the cellular device user and the retailers' physical outlet, which obtains the users' current location by initiating an asynchronous request to detect the user's position, and queries the positioning hardware in the cellular device to get up-to-date information from the location sources, being utilized to derive correction information in the cellular device by the application program about geographic positioning coordinate signals receivers, wherein the application program starts the location sources correction when the user has read the price tag with the digital signaling application program, the application program prompted by the user transmitting the read price tag information to the product database to be digitally stored in the created file;
a searching means analyzing the product database for the digital signals of the read product price tag to match the stored digital product signals with the transmitted read price tag information; and
means utilizing the geographical coordinate positioning signals locating the user, and the retailers outlet to distinguish the read price tag information when multiple products with similar digital signal information are found by the searching means, whereby the read price tag signaling is stored in the created user file, when determined to belong to the correct retailers outlet.

In one embodiment of the present invention it comprises to be adapted to interact with product information through said application program via electronic means, including the visualization, creation and edition of comments, reviews and ratings; related to the physical products recognized through said cellular device.

Another embodiment provides that it is adapted to share product information through said application program and via electronic means, including social media communications, in-app messaging, and electronic mail services, related to the physical product recognized through said cellular device, such product information being sharable via electronic means, and including at least some of the following information: product name, price, product images, product definition, features, availability information colors, sizes, ratings, and comments from other users and theirs.

A further embodiment provides that it is adapted to visualize, find, search, follow, create, access, organize, and edit and add products to an electronic list through the application program related to the physical products recognized through said cellular device, and such electronic lists include as many products recognized through a cellular device determined by said user of it.

Still a further embodiment provides that it is adapted to visualize products in 3-D through said application program and via the video feed of the cellular device, for products that have a 3-D model developed by the retailer and related to the physical products recognized through said cellular device, and for which the digital signals of the said product information, including the 3-D model, are indexed, categorized and stored in the invention product database.

Yet one embodiment provides that it is adapted to visualize, access and organize geographical content via geographically-specific data including but not limited to addresses, place names, or latitude and longitude coordinates through said application program, related to the physical products recognized through said cellular device.

Yet another embodiment provides that it is adapted to purchase the physical products recognized through said cellular device via electronic payment means, including but not limited to credit and debit cards, electronic wallets and accounts, net banking and invoicing solutions; and within the application program installed in said cellular device.

And yet another embodiment provides that it is adapted to include, access, edit and organize the retailers loyalty programs through said application program, and manage and synchronize the loyalty programs in connection with the physical products recognized through said cellular device, including but not limited to redemption of points, rewards and other loyalty benefits.

Moreover the present invention sets forth a method adapted to recognize a product through a cellular device, having a geographic positioning signaling means, utilized by a user of it. The method thus comprises:
scraping the web to extract digital signals of product information from retailers public websites;
utilizing a product database, wherein the extracted digital signals of the product information are indexed and stored in a catalogue file for the retailer, and the retailer's physical outlets geographical positioning coordinate signals being stored in the database;
utilizing a user's database, wherein recognized digital signals of the product information is stored in a file created by the user by online signaling of authorization to utilize the file;
adapting at least one digital signaling application program interface (API) for a retailer to connect to the product database catalogue file to update the digital signals of product information;
storing a digital application program (app) in the cellular device, providing the cellular device user to read a price tag with coded information regarding a product from the product in real time in a retailers outlet;
utilizing location sources whose position is accurately pin-pointed through its geographic position, thus geographically locating the cellular device user and the retailer's physical outlet, which obtains the user's current location by initiating an asynchronous request to detect the user's position, and queries the positioning hardware in the cellular device to get up-to-date information from the location sources, the location sources being utilized to derive correction information about nearby geographic positioning coordinate signals receivers, wherein the application program starts the location sources correction when the user has read the price tag with the digital signaling application program, the application program prompted by the user transmitting the read price tag information to the product database to be digitally stored in the created file;
searching to investigate the product database for the digital signals of the read product price tag to match the stored digital product signals with the transmitted read price tag information; and
utilizing the geographical coordinate positioning signals locating the user, and the retailers outlet to distinguish the read price tag information when multiple products with similar digital signal information are found by the searching means, whereby the read price tag signaling is stored in the created user file, when determined to belong to the correct retailers' physical outlet.

It is appreciated that the attached method sub claims adhere to the attached system sub claims.

### A BRIEF DESCRIPTION OF THE DRAWING

Henceforth, reference is had to the accompanying drawing throughout the present description for a better understanding of the present inventions embodiments, and given examples, wherein:

FIG. 1 schematically illustrates one embodiment of a system in accordance with the present invention.

### DETAILED DESCRIPTION OF PREFERRED EMBODIMENTS

The present invention relates to significantly improve a consumers shopping experience by introducing a system, and a method for that purpose. A product in the sense of the present invention could be any product equipped with a price tag. Moreover a cellular/mobile device could be any smart phone running an iOS®, Android operating system or the like with an embedded camera, with or without autofocus, and a GPS receiver in accordance with the present invention.

In the meaning of the present invention a retailer or merchant could be the same, but also be different ones.

An application program (app) utilizes computer vision technologies to allow consumers to identify the products of their choice. Users just need to open the app in their cellular device, point the camera of their cellular device towards the price tag of the product they like and scan the product price tag or focus on barcode or QR code 2D, bulls eye code, and analogous codes, which are all utilized on a price tag in accordance with the present invention. The system recognizes the product, and the app is provided real time information about that product including at least some of the following information; product name, price, product images, product definition, features, availability information (colors, sizes, etc.), ratings, and the like, and comments from other users and theirs. Users can share the products they've recognized with the app with other users and also via the usual social media channels. They are also able to rate the product and provide their feedback about it in one embodiment of the present invention. Moreover, users can add the products they've recognized with the app into lists, which in turn they can share and edit.

For products which have a 3-D modeling representation, for instance furniture, the app is designed to project a 3-D visualization of the product, virtual content, on the cellular device screen against the video feed, the area captured by the cellular device camera, thus seemingly locking it to the real world.

All the app's product recognition interactions are stored and the users can access their history at any time, review all the products they like, check the places they have been at.

The number of benefits that this system and method can bring to the consumers is unlimited and very much built by each user's own usage and experiences.

As previously mentioned, the mobile app is at the center of this invention. The app allows customers to interact with the products they like in the physical world adding the benefits from the digital channels. The mobile app distributed through the main ecosystems digital touch points like the Apple® Store, Google® Play, and the like. Consumers that download the app embody a version of the system in accordance with the present invention.

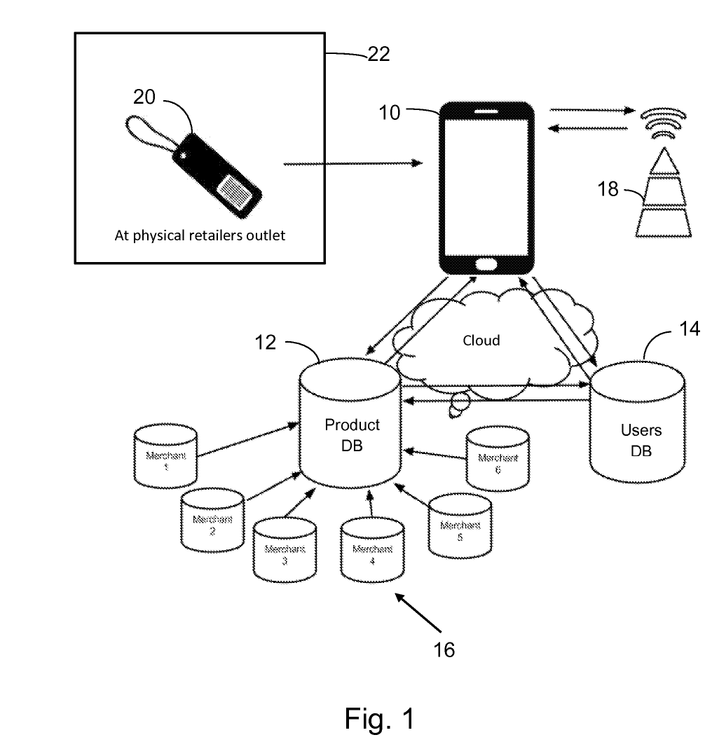

Now with reference to the single FIG. 1, the system of the present invention and its related method is described. Arrows depicted in FIG. 1 schematically illustrate electronic digitally modulated signaling between means in the system through the web/cloud. Hereby, FIG. 1 depicts a cellular device 10, which communicates with a product database (DB) 12, users of the cellular device database (DB) 14, merchants 1-6, 16 providing price-tagged goods to the product DB 12, a cellular device mobile base station (MBS) 18, providing accurate positioning coordinates in itself to be utilized to pin-point a corrected position of the GPS cellular device and its user. Alternatively, the user's current location is obtained by initiating an asynchronous request to detect the user's position, and queries the positioning hardware to get up-to-date information from the underlying location information sources which can include location inferred from network signals such as IP address, RFID, Wi-Fi and Bluetooth MAC addresses, and GSM/CDMA cell IDs, as well as user input. Moreover, FIG. 1 depicts price tag 20 bearing coded information about the product it is attached to in a physical retailer's outlet 22. The cellular device 10 in accordance with the present invention is equipped with a GPS receiver, a camera, or other device known to be able to read external codes for instance radio frequency identification codes (RFID) near field communication means (NFC), and others known to be utilized by a smart phone cellular device to read external codes. It is appreciated that at least three base stations 18 can be utilized to triangulate the position of the cellular device 10.

According to the present invention its system builds a database of products 12 based on publicly displayed information in retailers' websites or via the provision of the required data by the retailers/merchants 16 themselves via an Application Programming Interface (“API”). In the first case, a software known as “web scraping” is utilized for web harvesting, or web data extraction, to discover product information in publicly available webpages. Web scraping is a computer software technique of extracting information from websites. Web scraping is closely related to web indexing, which indexes information on the web using a bot or a web crawler, and it is a universal technique adopted by most search engines. The system scrapes retailers' websites and imports certain digital data fields of product information towards its database 12.

The web/cloud is like an ever-growing public library with billions of products and no central filing system. The system essentially gathers the webpages during the scraping process and then creates a database 12, so to know exactly how to look things up. The system database 12 organizes the imported information by indexing, categorizing and storing it.

Selection of retailers/merchants 22, 16 websites which information is extracted is based on several factors, such as the possibility to link that retailers' products price tags and/or 2D codes, barcode, and QR codes, with a specific product in their website; the fact that a retailer has both offline and online presence (“brick and click”); their commercial appeal, international presence, turnover, or the like.

In the second case, in where the system's product database 12 is populated with the information fetched from retailers via APIs, the system specifies how the system's product database 12 should interact with the retailer's product catalogue database/s. The system's product database API provides a standard abstraction layer for accessing the retailers' database servers 1-6 and extract a standard dataset composed of: product code (following the global GS1 specification which bases on international standards—such as UPC or EAN—or following other bar code symbologies and other article number systems), product name, images and sub-images, price (possibly in multiple currencies), product description, sizes, available colors, retailer logo, retailer name, retailer URL, product URL, raw data, retailers' physical outlets locations and geo-coordinates, and other possible product information.

When a customer opens the mobile application in their cellular device 10, the system will geographically locate the user via the cellular device GPS system and alternatively signaling towards the in proximity wireless mobile base station 18. Base stations are GPS receivers at an accurately known fixed location which is used to derive correction information for nearby portable GPS receivers comprised in cellular devices 10. This correction data allows propagation and other effects to be corrected out of the position data obtained by the mobile stations 18, which gives greatly increased location precision and accuracy over the results obtained by uncorrected GPS receivers. The system can use the users' cellular device GPS system and also Wi-Fi access point information, which is similar to the base stations 18 functioning. The users' current location is obtained by initiating an asynchronous request to detect the user's position, and queries the positioning hardware to get up-to-date information from the underlying location information sources which can include location inferred from network signals such as IP address, RFID, Wi-Fi and Bluetooth MAC addresses, and GSM/CDMA cell IDs, as well as user input. These devices whose position coordinates are exactly known are referred to as location sources in the attached claims.

A user that has opened the mobile application, points the camera towards physical retailer's outlet 22 products price tag 20 and the mobile application will automatically scan the barcode or QR code in the price tag 20. The system decodes the information contained in that barcode and QR code and queries the decoded output data towards' the system product database 12. If there is a match in the database 12, the system will send back the correspondent product information, which will be automatically displayed in the cellular device 10 mobile program application, app.

In case the system could not scan the barcode or QR code in the price tag 20, the system would alternatively scan the whole price tag via optical character recognition software (“OCR”), which is the electronic conversion of scanned images of printed text into machine-encoded text. The system then decodes the printed text in that price tag 20 and the related digital data output would be queried against the system product database 12. If there is a match in the database 12, the system sends back the correspondent product information, which will be automatically displayed in the mobile application on the cellular device 10 display screen.

If the system did not find a match in its database 12 either via barcode/QR code scanning or OCR, the system would return an error message which in turn would inform the user via a displayed message in the mobile application that that product is not in the system's product database 12.

Where there is a conflict between multiple matches, i.e., the barcode/QR code scanning or price tag OCR scanning would trigger more than one match in the system database 12; the system determines the right match in the database and therefore, the right product information to provide to the user via product information display in the mobile application, based on the user's geographical position which has been cached and stored in the system's user database 14. To accomplish that, the system's product database 12 crosses the results with the system's user database 14, so that a higher accuracy match based on the user's physical location close to a certain retail outlet can be provided.

In order to summarize, the preferred embodiment of the present invention through the schematically depicted system in FIG. 1 illustrates a system adapted to recognize a product through a cellular device 10, having a geographic positioning signaling means, utilized by a user of it. Hereby, it comprises a web scraping means to extract digital signals of product information from merchants' 16 public websites. It also comprises a product database 12, wherein the extracted digital signals of the product information are indexed and stored in a catalogue file for the retailer, and the retailers physical outlets 22 geographical positioning coordinate signals being stored in the database 12;

Furthermore the system comprises a user database 14, wherein recognized digital signals of the product information are stored in a file created by the user by online signaling of authorization to utilize the file. Retailers 22 have at least one digital signaling application program interface (API) adapted for a retailer 22 to connect to the product database 12 catalogue file to update the digital signals of product information. The cellular device 10 is provided a digitally stored application program (app), enabling the cellular device 10 user to read a price tag 20 with coded information regarding a product from the product in real time in a retailer's physical outlet 22.

To distinguish between multiple hits in the database 12 for a scanned product tag 20, the system utilizes for instance, or other location sources as mentioned above, the cellular device GPS system and alternatively the cellular network base station 18 in proximity to the user of the cellular device utilized to signal geographic positioning coordinate signals, whose position is accurately pin-pointed through its geographic position, thus geographically locating the cellular device 10 user and the retailers outlet 22, which obtains the user's current location by initiating an asynchronous request to detect the user's position, and queries the positioning hardware in the cellular device 10 to get up-to-date information from the location sources, the location source 18, being utilized to derive correction information, by means for that in the application program (app) together with the cellular device 10 GPS hardware, about nearby geographic positioning coordinate signals receivers signaling their exact positions, wherein the application program starts the base station 18 point signaling when the user has read the price tag 20 with the digital signaling application program, the application program prompted by the user transmitting the read price tag information to the product database 12 to be digitally stored in the created file.

Moreover, the system provides a searching means analyzing the product database 12 for the digital signals of the read product price tag 20 to match the stored digital product signals with the transmitted read price tag information, and means utilizing the geographical coordinate positioning signals locating the user, and the retailer's physical outlet 22 to distinguish the read price tag 20 information when multiple products with similar digital signal information are found by the searching means, whereby the read price tag 20 signaling is stored in the created user file, when determined to belong to the correct retailer's 22 outlet.

The attached set of claims determines other possible embodiments of the present invention to a person skilled in the art of the present technical field.

1. A system adapted to recognize a product through a cellular device, having a geographic positioning signaling means, utilized by a user of it, comprising:
a web scraping means to extract digital signals of product information from merchants' public websites;
a product database, wherein said extracted digital signals of said product information are indexed, categorized and stored in a catalogue file for a retailer, and said retailers physical outlets geographical positioning coordinate signals being stored in said database;
a user database, wherein recognized digital signals of said product information are stored in a file created by the user by online signaling of authorization to utilize said file;
at least one digital signaling application program interface (API) adapted for a merchant to connect to said product database retailers catalogue file to update said digital signals of product information;
a digitally stored application program (app) in said cellular device, providing said cellular device user to read a price tag with coded information regarding a product from said product in real time in a retailer's physical outlet;
a location source in proximity to said user of said cellular device utilized to provide geographic positioning coordinate signals, whose position is accurately pin-pointed through its geographic position, thus geographically locating said cellular device user and said retailer's physical outlet, which obtains the user's current location by initiating an asynchronous request to detect the user's position, and queries the positioning hardware in said cellular device to receive up-to-date information from the underlying location information sources, thus geographically locating said cellular device user, and said retailers' physical outlet, wherein said application program starts said underlying location information sources signaling when the user has read the price tag with the digital signaling application program, said application program prompted by said user transmitting said read price tag information to said product database to be digitally stored in said created file;
a searching means analyzing said product database for said digital signals of said read product price tag to match said stored digital product signals with said transmitted read price tag information; and
means utilizing said geographical coordinate positioning correction locating said user, and said retailer's outlet to distinguish said read price tag information when multiple products with similar digital signal information are found by said searching means, whereby said read price tag signaling is stored in said created user file, when determined to belong to the correct retailers physical outlet.

2. A system according to claim 1, wherein it is adapted to interact with product information through said application program via electronic means, including the visualization, creation and edition of comments, reviews and ratings; related to the physical products recognized through said cellular device.

3. A system according to claim 1, wherein it is adapted to share product information through said application program and via electronic means, including social media communications, in-app messaging, and electronic mail services, related to the physical product recognized through said cellular device, such product information being sharable via electronic means, and including at least some of the following information: product name, price, product images, product definition, features, availability information colors, sizes, ratings, and comments from other users and theirs.

4. A system according to claim 1, wherein it is adapted to visualize, find, search, follow, create, access, organize, and edit and add products to an electronic list through the application program related to the physical products recognized through said cellular device, and such electronic lists include as many products recognized through a cellular device determined by said user of it.

5. A system according to claim 1, wherein it is adapted to visualize products in 3-D through said application program and via the video feed of the cellular device, for products that have a 3-D model developed by the retailer and related to the physical products recognized through said cellular device and for which the digital signals of said product information, including the 3-D model, are indexed, categorized and stored in the invention product database.

6. A system according to claim 1, wherein it is adapted to visualize, access and organize geographical content via geographically-specific data including addresses, place names, or latitude and longitude coordinates through said application program, related to the physical products recognized through said cellular device.

7. A system according to claim 1, wherein it is adapted to purchase the physical products recognized through said cellular device via electronic payment means, including credit and debit cards, electronic wallets and accounts, net banking and invoicing solutions, and within the application program installed in said cellular device.

8. A system according to claim 1, wherein it is adapted to include, access, edit and organize the retailers loyalty programs through said application program, and manage and synchronize the loyalty programs in connection with the physical products recognized through said cellular device, including—redemption of points, rewards and other loyalty benefits.

9. A method adapted to recognize a product through a cellular device, having a geographic positioning signaling means, utilized by a user of it, comprising:
scraping the web to extract digital signals of product information from merchants' (16) public websites;
utilizing a product database, wherein said extracted digital signals of said product information are indexed, categorized and stored in a catalogue file for a retailer, and said retailers physical outlets geographical positioning coordinate signals being stored in said database;
utilizing a user database, wherein recognized digital signals of said product information is stored in a file created by the user by online signaling of authorization to utilize said file;
adapting at least one digital signaling application program interface (API) for a merchant to connect to said product database catalogue file to update said digital signals of product information;
storing a digital application program in said cellular device, providing said cellular device user to read a price tag with coded information regarding a product from said product in real time in a retailers physical outlet;
utilizing location sources whose position is accurately pin-pointed through its geographic position, thus geographically locating said cellular device user and said retailers physical outlet, which obtains said users' current location by initiating an asynchronous request to detect said user's position, and queries the positioning hardware in said cellular device to get up-to-date information from said location sources, said location sources being utilized to derive correction information about nearby geographic positioning coordinate signals receivers, wherein said application program starts said location sources correction when said user has read said price tag with said digital signaling application program, said application program prompted by the user transmitting said read price tag information to said product database to be digitally stored in said created file;
searching to analyze said product database for said digital signals of said read product price tag to match said stored digital product signals with said transmitted read price tag information; and
utilizing said geographical coordinate positioning signals locating said user, and said retailer's outlet coordinate signals to distinguish said read price tag information when multiple products with similar digital signal information are found by said searching means, whereby said read price tag signaling is stored in said created user file, when determined to belong to the correct retailer's outlet.

10. A method according to claim 9, wherein it interacts with product information through said application program via electronic means, including the visualization, creation and edition of comments, reviews and ratings; related to the physical products recognized through said cellular device.

11. A method according to claim 9, wherein it shares product information through said application program and via electronic means, including social media communications, in-app messaging, and electronic mail services, related to the physical product recognized through said cellular device, such product information being sharable via electronic means, and including at least some of the following information: product name, price, product images, product definition, features, availability information colors, sizes, ratings, and comments from other users and theirs.

12. A method according to claim 9, wherein it visualizes, finds, searches, follows, creates, accesses, organizes, edits, and adds products to an electronic list through the application program related to the physical products recognized through said cellular device, and such electronic lists include as many products recognized through a cellular device determined by said user of it.

13. A method according to claim 9, wherein it visualizes products in 3-D through said application program and via the video feed of the cellular device, for products that have a 3-D model developed by the retailer and related to the physical products recognized through said cellular device device and for which the digital signals of the said product information, including the 3-D model, are indexed, categorized and stored in the invention product database.

14. A method according to claim 9, wherein it visualizes, accesses, and organizes geographical content via geographically-specific data including addresses, place names, or latitude and longitude coordinates through said application program, related to the physical products recognized through said cellular device.

15. A method according to claim 9, wherein it purchases the physical products recognized through said cellular device via electronic payment means, and including credit and debit cards, electronic wallets and accounts, net banking and invoicing solutions, and within the application program installed in said cellular device.

16. A method according to claim 9, wherein it includes, accesses, edits and organizes the retailers loyalty programs through said application program, and manages and synchronizes the loyalty programs in connection with the physical products recognized through said cellular device, including redemption of points, rewards and other loyalty benefits.
